(19) United States
(12) Patent Application Publication
(10) Pub. No.: US 2007/0203728 A1
(43) Pub. Date: Aug. 30, 2007

(54) System and method for facilitating integration of automated applications within a healthcare practice

(76) Inventors: Jeffrey A. Simon, Marietta, GA (US); Ronald J. Sampson JR., Sugar Hill, GA (US)

Correspondence Address: CLEMENTS WALKER, 1901 ROXBOROUGH ROAD, SUITE 300, CHARLOTTE, NC, 28211, US

(21) Appl. No.: 11/492,977

(22) Filed: Jul. 26, 2006

Related U.S. Application Data
(60) Provisional application No. 60/702,426, filed on Jul. 26, 2005.

(51) Int. Cl. G06Q 10/00; G06Q 30/00

(52) U.S. Cl. 705/1

(57) ABSTRACT

The invention provides a system and method of building an application interface which permits the easy building of translation and transformation rules to integrate seamlessly with existing applications and devices used in a healthcare practice.

### CROSS REFERENCE TO RELATED APPLICATIONS

This application relates to and claims priority benefit under 35 U.S.C. § 119(e) to U.S. Provisional Patent Application Ser. No. 60/702,426, entitled “Cross Mapping Technology”, filed Jul. 26, 2005. U.S. patent application Ser. No. 10/935,448, entitled “Patient Workflow Process”, filed Sep. 7, 2004 and U.S. patent application Ser. No. 11/207,156, entitled “Global Synchronization Technology,” filed Aug. 18, 2005 are hereby incorporated by reference in the entirety and made part hereof.

### FIELD OF THE INVENTION

The invention relates to a graphical user interfaces used to manage coordination of information between various computer applications and hardware devices being utilized within medical applications such as those used within a medical practice.

### BACKGROUND OF THE INVENTION

Within the medical field, there are a number of commercial products that contain a variety of databases for patient personal data, medical records, procedures, equipment, billing, etc. These databases contain information that covers the patients, the providers, and the insurers, etc. For many of these commercial products, there are huge problems of privacy, security, and accountability that dampen their efficacy and reliability within the medical field. With numerous medical providers, e.g. doctors, nurses, technicians, residents, etc. entering information for a single patient from various places in one physical location (i.e. a hospital) or from several remote locations (e.g. a hospital, an outpatient clinic, a doctor's office, etc.), synchronization is key to forming a single, unified, and up-to-date record for any particular patient or medical practice.

The Tablet MD manufactured by WiFiMed, LLC of Keenland, Ga., captures and deciphers the practitioner's clinical documentation on a wireless-mobile-Tablet PC, which is familiar in size and portability to the charts currently used. The Tablet MD user can instantly create or update a medical record and treatment plan, execute the prescribed treatment plan, retrieve the results and return them digitally, wirelessly and on the fly. All outstanding information and unfinished tasks are automatically tracked, so the physician is assured that their clinical and regulatory obligations are met.

One of the major concerns of any healthcare practice is the coordination of information between the various computer applications and hardware devices being utilized by the practice. In addition, it is essential to move interface development out of software engineering and into operation's customer support area. The present invention provides a system and method for implementation in a patient workflow process operating on a Tablet MD that addresses the longstanding needs prevalent in the healthcare practice and database management fields.

### SUMMARY OF THE INVENTION

According to an embodiment of the invention, provided is a system for facilitating integration of automated applications within a healthcare practice, comprising a first client; a second client; a server facility configured to be accessed via a data network by each client and to send data to and receive data from automated application facilities residing on each client; a plurality of data processing schemes, wherein each automated application facility operates in accordance with one of said data processing schemes; and a software delegate residing on said server facility and configured to display and associate data in each data processing scheme to a set of business rules and to present the associated data on an interface generated by the software delegate.

According to another embodiment of the invention, provided is a system for facilitating integration of automated applications within a healthcare practice, comprising a first automated application facility operating in accordance with a first data processing scheme; a second automated application facility operating in accordance with a second data processing scheme; and an integration facility configured to process data in accordance with said first and second data processing schemes, to build a graphical user interface based on said first and second data processing schemes, and to construct an integrated healthcare application based on said first and second automated application facilities.

According to another embodiment of the invention, provided is a system for facilitating integration of automated applications within a healthcare practice, comprising a plurality of data processing schemes; a plurality of automated application facilities, each operating in accordance with a data processing scheme; and an integration facility configured to process data in accordance with said first and second data processing schemes, to build a graphical user interface based on said first and second data processing schemes, and to construct an integrated healthcare application based on said first and second automated applications facilities.

Another embodiment of the invention relates to a method for facilitating integration of automated applications within a healthcare practice, comprising the steps of building a user interface that examines a first and second automated application facility for data elements, wherein each automated application facility contains a set of data elements; producing a graphical representation of each set of data elements; displaying the graphical representation; relating the set of data elements corresponding to the first automated application facility with the set of data elements corresponding to the second automated application facility wherein the sets of data elements are related by connecting data stored in each set of data elements; displaying the connected data elements; tagging the connections to allow a user to define a set of business rules, wherein said business rules are associated with the connected data elements; saving the business rules and associated data elements; generating executable code pertaining to the saved business rules and associated data elements; executing the code to generate a detailed log of the business rules and associated data elements; and reviewing said log to determine the existence of errors in the integration of the first and second automated application facilities.

### BRIEF DESCRIPTION OF THE ATTACHED DRAWING FIGURES AND APPENDICES

The present invention is shown in the appended drawing figures of which:

FIG. 1 is an illustration of exemplary associated data fields.

FIG. 2 illustrates a mapping display of the data fields shown in FIG. 1.

FIG. 3 depicts the mapping relationships of the data fields shown in FIG. 2.

FIG. 4a is a flow chart of the first portion of the interface building process.

FIG. 4b is a flow chart of the second portion of the interface building process.

FIG. 5 illustrates the business rule screen of the interface building process.

Appendix 1 is illustrative XML transformation format depicting an example of the administrative functions used in the present invention.

Appendix 2 is illustrative XML Import/Export format exemplified by the present invention.

### DETAILED DESCRIPTION OF THE PREFERRED EMBODIMENTS

For the purposes of promoting an understanding of the principles of the invention, reference will now be made to the embodiments of the present invention illustrated in the drawing figures briefly described above. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

The system and method of the present invention incorporates functionality allowing a user to graphically migrate data from one format to another. The mapping technologies include the following formats and actions: Database to Database—Synchronized, HL7—Import/Export, 837—Export Only, ASCII—Export Only, ASCII—Import Only, and Device to Tablet MD™—Import.

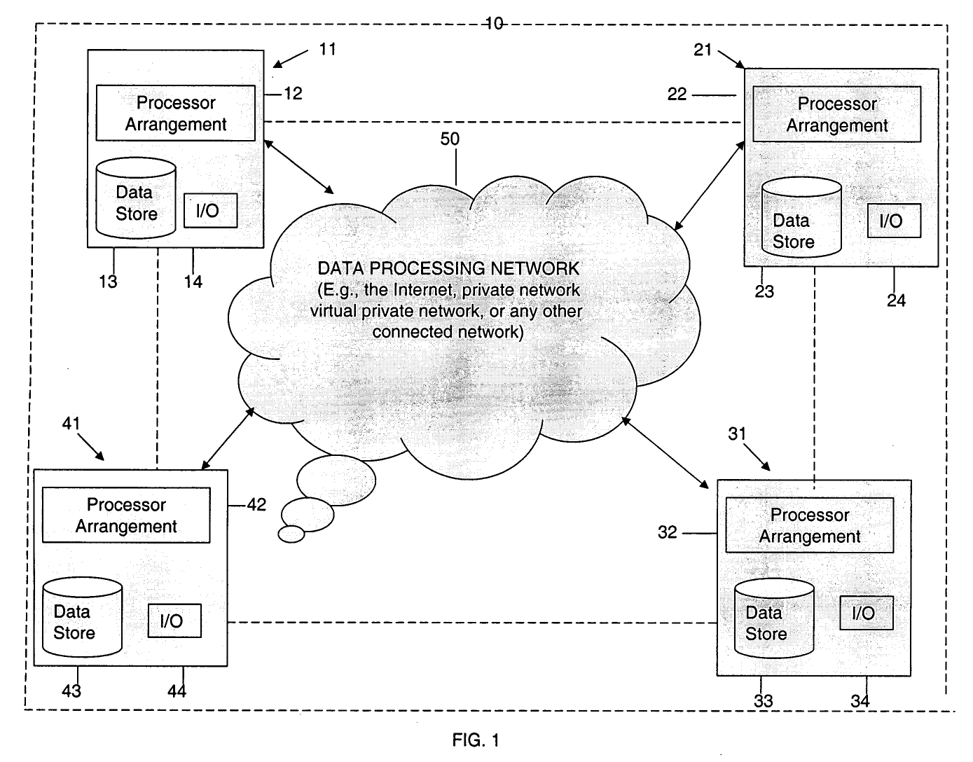

With reference to FIG. 1, the system and method of the present invention operate in accordance with a data processing scheme 10, having a data processing network 50, connecting automated application facilities 11, 21, 31, and 31 respectively. The data processing network 50 may be the Internet, a private network, a virtual private network or any other connected network. Each automated application facility contains a processor arrangement 12, 22, 32, and 42; a data store 13, 23, 33, and 43; and an Input/Output (I/O) 14, 24, 34, and 44. Automated application facility 11 is also acting as an integration facility. Integration facility 11 is coupled to automated application facilities 21, 31 and 41 via data processing network 50.

The approach is to build a user interface that examines the application or device requiring an interface and produce a graphical map of the elements which are available. There are several different ways this graphical map is produced. If an electronic document is available with the interface requirements, this can be input to Tablet MD™ and the graphical representation displayed. If a database schema can be automatically generated by interfacing with the software application, then Tablet MD can produce the graphical representation. If a device has a particular output mode such as WAV, JPEG, DiComp, MP3, etc. Tablet MD includes the capability to read these elements into its data storage. If no convenient information is available, then Tablet MD provides a manual methodology to build the graphical interface.

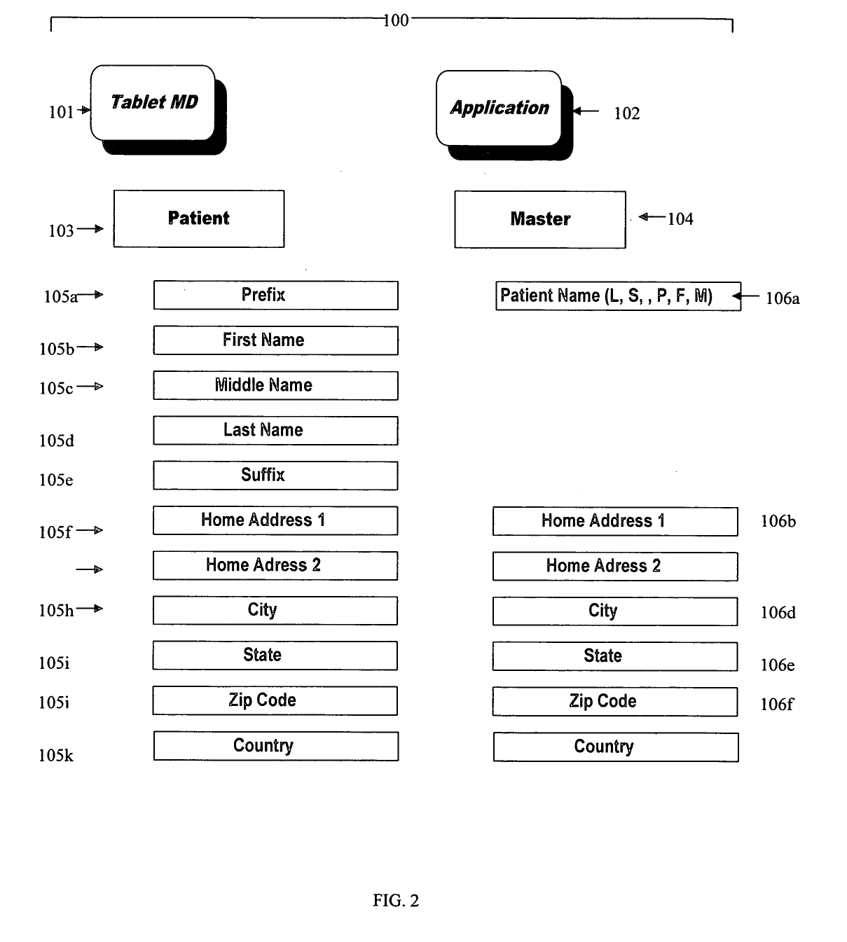

Once the associated application or device is graphically portrayed, Tablet MD then layers in the graphic portrayal of its own schema for record/field representation. The user can control what is displayed by picking the records to be displayed. FIG. 2 depicts an illustration of exemplary associated data fields. Screen 100 is a demonstrative screen shot containing data fields from an external application 102 that are to be merged into a Tablet MD 101 database. The fields for “Patient” 103 and “Master” 104 represent the heading of the data field sets for the respective applications. 20 The “Patient” 103 set contains the following fields: “Prefix” 105a, “First Name” 105b, “Middle Name” 105c, “Last Name” 105d, “Suffix” 105e, “Home Address 1” 105f, “Home Address 2” 105g, “City” 105h, “State” 105i, “Zip Code” 105j, and “Country” 105k. The data field set for “Master” 104 contains the following fields: “Patient Name” 106a, “Home Address 1” 106b, “Home Address 2” 106c, “City” 106d, “State” 106e, “Zip Code” 106f, and “Country” 106g. The “Patient Name” 106a contains the specific order in which the subparts of the patient's identity are to be recorded—Last Name, Suffix, Prefix, First Name, and Middle Name.

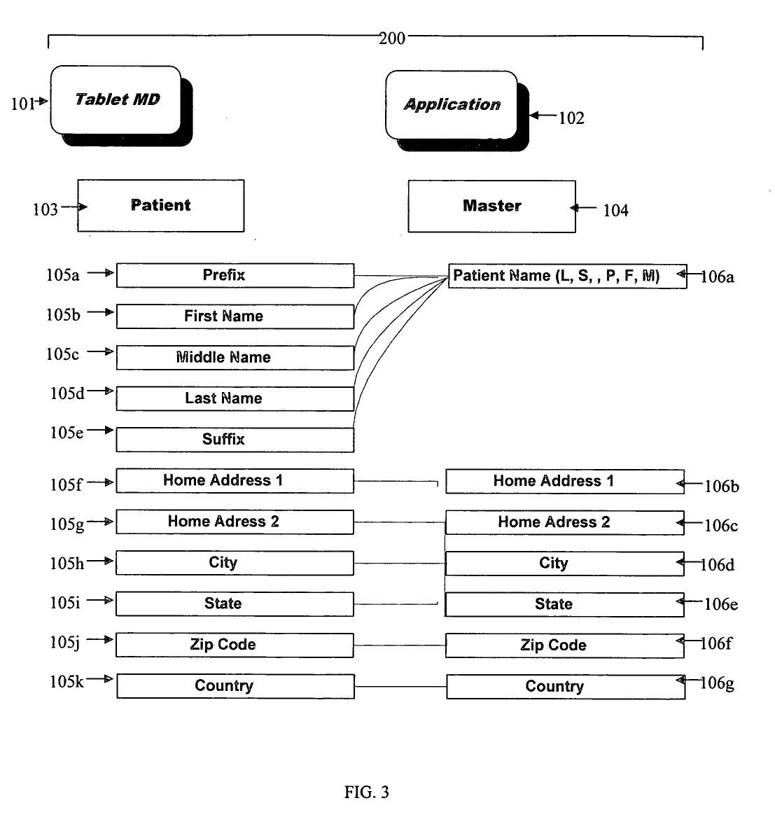

Once the two applications are displayed, the user can then relate one set of elements to the other. This is done by connecting boxes and defining rules by selecting those rules. Connections are shown in the diagram provided in FIG. 3. Screen 200 is a mapping display of the associated data fields presented in screen 100. Connecting lines are drawn from the data fields in the set 104 for “Master” to the data fields in “Patient” set 103. A first grouping of connecting lines are drawn from the “Patient Name” field 106a to “Prefix” 105a, “First Name” 105b, “Middle Name” 105c, “Last Name ” 105d, and “Suffix” 105e fields, respectively. Connecting lines are drawn from “Home Address 1” 106b to “Home Address 1” 105f, “Home Address 2” 106c to “Home Address 2” 105g, “City” 106d to “City” 105h, “State” 106e to “State” 105i, “Zip Code” 106f to “Zip Code” 105j, and “Country” 106g to “Country” 105k.

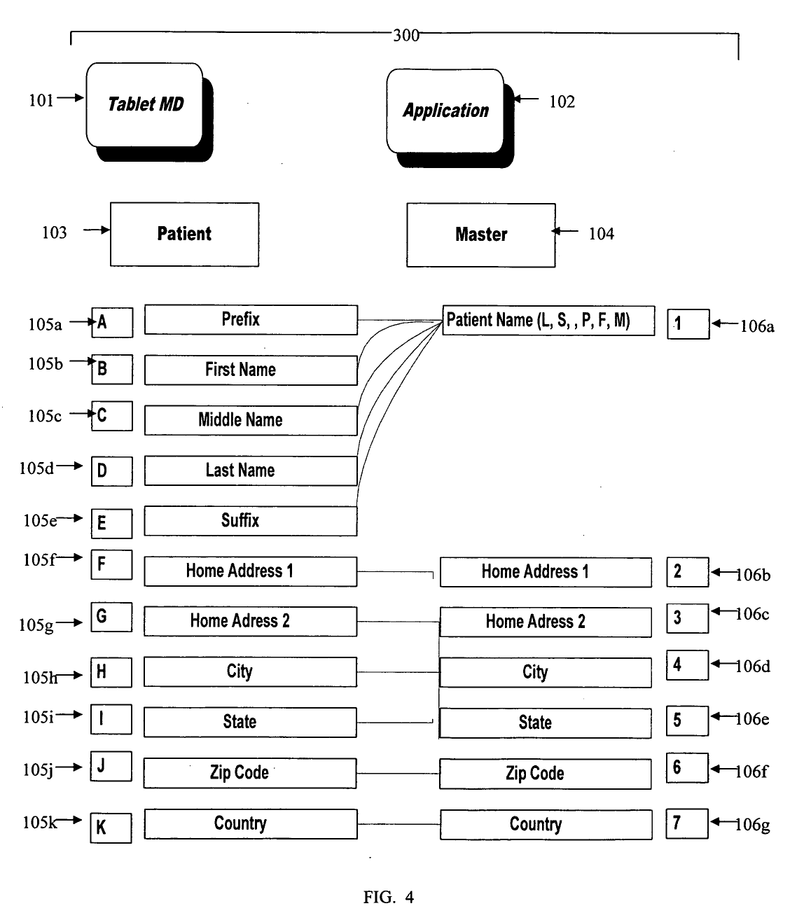

Once the connections are shown, the connections are automatically tagged by the application to allow a user to define the business rules associated with the elements. The business rules would look as follows: parse Field 1 into 5 parts using space and commas as delimiters—and show in order as 1a, 1b, 1c, 1d, 1e.; equate fields A to 1a, B to 1b, C to 1c, D to 1d, E to 1e, F to 2, G to 3, H to 4, I to 5, J to 6, and K to 7; and establish synchronization between fields. This is depicted in screen 300 of FIG. 4.

### Block Commands

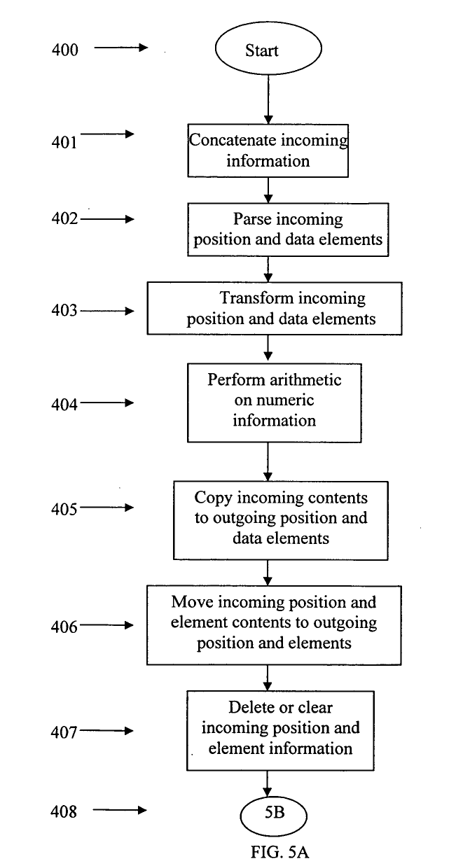

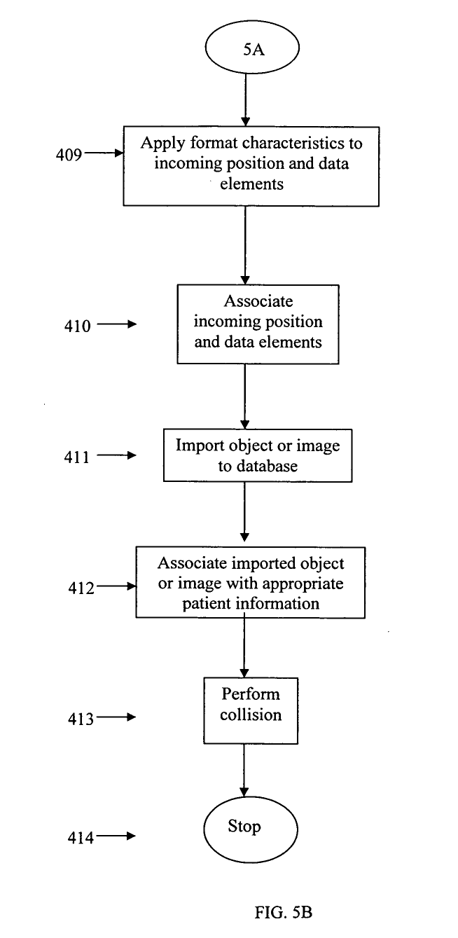

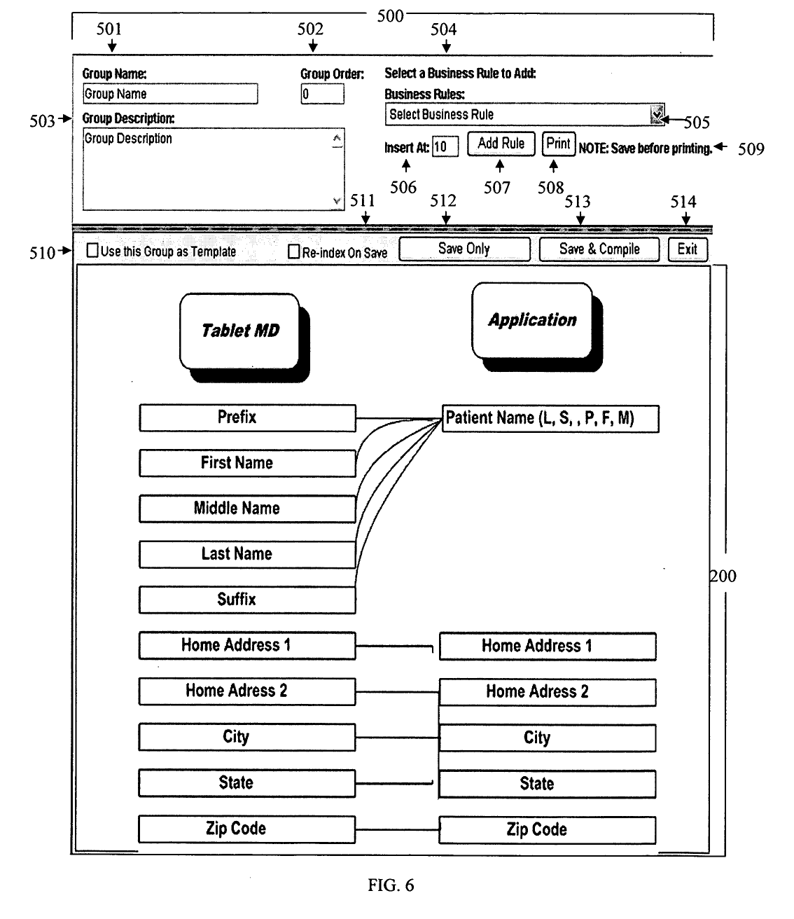

The building of interfaces requires operations which need to move and translate data from applications and devices and the Tablet MD application. FIGS. 5a and 5b depict flow charts of the processes described above. In step 400, the interface building process is started. In step 401, using Incoming Position and Data Elements, information is concatenated in the order of the data elements with spaces in between and store in Outgoing Position and Data Element. Using Incoming Position and Data Elements, parsing is performed in step 402 based on character in Option field and stored in sequential order parsed in Outgoing Position and Data Elements. Based on rules in Option field, the Incoming Position and Data Element are transformed and the results are stored in Outgoing Position and Data Element fields in step 403. Based on mathematical operation in Option field, arithmetic is performed in step 404 on numeric information contained in the Incoming Position and Data Elements and the result is stored in Outgoing Position and Data Element fields.

In step 405, the contents contained in one or more fields in the Incoming Position and Data Elements are copied to the Outgoing Position and Data Elements on a one to one basis. In Step 406, the contents contained in one or fields in the Incoming Position and Data Elements are moved to Outgoing Position and Data Elements on a one to one basis. Information contained in the Incoming Position and Data Elements is deleted or cleared in step 407. The process continues to the second part of the information building method, as depicted in FIG. 4b. This is illustrated by step 408.

In step 409, using formatting rules found in the Option field, format characteristics are applied to fields defined by the Incoming Position and Data Elements. Information found in the fields of the Incoming Position and Data Elements is associated in step 410 with fields pointed to by the Outgoing Position and Data Elements on a one to one basis (acts as an instance). Objects or images are moved in step 411 to a database and associated in step 412 with appropriate patient, encounter, date, and process steps of a patient encounter. Lastly, the collision process occurs in step 413, which is defined a rule modifier that indicates when a field is changed in Tablet MD and the synchronized database and how it is to be handled. The flow charts shown in FIGS. 5a and 5b could operate on integration facility 11.

### Overall Function Implementation

These operations are initiated through a toolbar which is depicted in FIG. 6. The screen shot 500 shows the work area from which the user views the graphic 200 displaying Tablet MD versus the application or device having an export or import operation performed. The user may visually hide any elements on either side of the display in order to work with the information applicable. The application determines, based on field names, the possible match between the Tablet MD application and foreign application. A group name 501 is determined, along with a group order 502 and a group description 503. The user may remove any relationship built by the Tablet MD application. The user manually selects either one field or multiple fields in Tablet MD and then selects one or multiple fields in the foreign application or device. Note field 504 instructs the user to select a business rule to add to the Tablet MD and foreign application match. By using the drop down “Select Business Rule” box 505 which lists the operations, relationships are established and diagramed. The insert position is set forth in field 506. The button 507 is depressed by the user to add the rule to the match. The print button is depicted as button 508, along with a reminder note to the user to save the completed steps before printing the screen.

Boxes 508 and 509 are checked by the user in the event that he or she desired to use the selected group as a template and/or to re-index the group upon saving. In order to save the screen, the user depresses button 512. Button 513 is selected to save and compile the entered data. The user may exit the screen by depressing button 514. By passing a stylus or mouse over the drawn relationship the user can view the business rule selected.

The user can save the operations and their relationships as a template to be used with other import/export operations. When the user clicks on the SAVE & COMPILE button 513, Tablet MD generates executable code. The user is asked when the code should be run—timing—and a schedule task is recorded. When the task executes, a detailed log is generated which allows for review to determine how the process performed or if errors occurred in the transformation process.

Tablet MD has established an XML-like format transfer format which it used with its function to update practice databases and the transfer of format information between practices and WiFiMed's operation center. An example of such a format is set forth in Appendix 1. In Appendix 2, an exemplary XML output format employed by Tablet MD to pass information in and out of the application is provided.

Each of the formats which are handled by Tablet MD and the special processing for each of the formats are outlined below.

### Database to Database—Import/Export

Tablet MD identifies the type of database being interrogated. Databases could be proprietary formats, SQL-oriented, object-oriented, or relational/network. If the database has a schema which is accessible, then Tablet MD is able to import the schema to its design sub-system and display it as shown in FIG. 6. If the schema is not readable, then the schema needs to be input manually based on information received from the vendor. Once the schema is imported and displayed, Tablet MD attempts to match fields in its database to the foreign database by comparing the schemas. Relationships are shown as displayed in FIG. 6. These relationships can be changed by the user or the operation assigned by the automated process modified.

Because Tablet MD must continually synchronize its database with the foreign database, a copy of the database is made after each import/export. The next time synchronization takes place the previous foreign database is compared to the current foreign database. The new or modified records are marked for synchronization. When collisions occur between databases, either a collision rule is applied, or the user is informed of the collision so that a manual resolution can be made.

### HL7—Import/Export

Currently, there is no consistent schema for HL7 export/import environments. There is a requirement for a HL7 specialist to be assigned and resolve the differences between Tablet MD HL7 implementation and the application outputting HL7. This resolution is done through the interface common XML-like code as shown in Appendix 2. Using a Tablet MD mechanism similar to that depicted in FIG. 6, the specialist constructs block commands to transform the other application into the required code. This is done by building XML snippets tied to HL7 coded segments which automate the transformation process. XML snippets are applied to the application HL7 output which will then allow Tablet MD to produce FIG. 6. Two processes must be put in place to transform data between Tablet MD and another application. First, the other application may only output new or modified data. Second, the other application may not differentiate between new or modified data. The first is easy to resolve because the compiled operation will act only on the HL7 generated by the other application. Second requires a similar technique as with database transformation and that is maintaining a copy of the previous HL7 export and compare it to the current HL7 export. Comparisons are made using the XML-like interface and only changes output to be used with the operation transformations.

### ASC 837 Format Export

This is the new billing format to allow electronic transmission of billing information from practice to the insurance company. Currently hospital use one form and practices use another. ASC x12 837 unites these formats into a unified one which both hospitals and practices will use. Tablet MD will display those tables and elements and the transformation requirements to export in the ASC 837 format. The user will be able to modify the display and the relationships as with other formats. The original implementation will be manual and then mapping techniques will apply to update or modify the existing transformation. There is a requirement to have different transformation requirements for each specialty. WiFiMed is able to provide export to ASC 837 for psychiatry, orthopedics, and GYN specialties and will extend that capability to other specialties as they come on line.

### ASCII Format Export/Import

Based on information provided by the vendor using this format, a specialist will develop the XML code base. Each vendor's ASCII file format will need to be developed manually. Once the XML code base is developed, Tablet MD will display its database and the ASCII transformed file system to allow operations to be applied and relationships displayed. Two processes must be put in place to transform data between Tablet MD and the ASCII file format application. First, the other application may only output new or modified data. Second, the other application may not differentiate between new or modified data. The first is easy to resolve because the compiled operation will act only on the ASCII generated by the other application. Second requires a similar technique as with database transformation and that is maintaining a copy of the previous ASCII export and compare it to the current ASCII export. Comparisons are made using the XML-like interface and only changes output to be used with the operation transformations.

### Device to Tablet MD Import

Various devices are used by physicians for diagnostic and curative procedures. These devices utilize the following formats: Laboratory results, Images in DiComp format, Strip Charts, Graphic images, Video, and Audio. WiFiMed develops individual import mechanisms for each format and then handles each of these formats under scanning technology to store the information in formats which can easily be displayed as part of the encounter. The scanning subsystem displays a list of images or objects for selection and association with a patient, date of encounter, and step.

As each code block for each format is developed and stored in the Tablet MD database, it is event scheduled to run automatically. The user is asked for the date, time, and frequency to run the transformations. Database to Database transformations may run every 5 minutes while image and object transformations will only run when requested. As the transformations are processed, a log file is created. If a manual procedure is taking place, the log file is displayed as the process is running. If the process is automatic, the log file is created and stored as version and a message is sent to the user requesting the transformation when the transformation is completed.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A system for facilitating integration of automated applications within a healthcare practice, comprising:
a first client;
a second client;
a server facility configured to be accessed via a data network by each client and to send data to and receive data from automated application facilities residing on each client;
a plurality of data processing schemes, wherein each automated application facility operates in accordance with one of said data processing schemes; and
a software delegate residing on said server facility and configured to display and associate data in each data processing scheme to a set of business rules and to present the associated data on an interface generated by the software delegate.

2. The system of claim 1, wherein the data contains a plurality of elements corresponding to information for a patient in a healthcare practice.

3. The system of claim 1, wherein the presentation of the data occurs independently of a user of the client, and based solely upon the operating state of said client and wherein the operating state is an active state of synchronizing the data received from and sent to each automated application facility.

4. The system of claim 1, wherein the presentation of the data occurs by manually inputting the data into the generated interface.

5. A system for facilitating integration of automated applications within a healthcare practice, comprising:
a first automated application facility operating in accordance with a first data processing scheme;
a second automated application facility operating in accordance with a second data processing scheme; and
an integration facility configured to process data in accordance with said first and second data processing schemes, to build a graphical user interface based on said first and second data processing schemes, and to construct an integrated healthcare application based on said first and second automated application facilities.

6. The system of claim 5, wherein the data contains a plurality of elements corresponding to information for a patient in a healthcare practice.

7. A system for facilitating integration of automated applications within a healthcare practice, comprising:
a plurality of data processing schemes;
a plurality of automated application facilities, each operating in accordance with a corresponding data processing scheme; and
an integration facility configured to process data in accordance with said first and second data processing schemes, to build a graphical user interface based on said first and second data processing schemes, and to construct an integrated healthcare application based on said first and second automated applications facilities.

8. The system of claim 7, wherein the data contains a plurality of elements corresponding to information for a patient in a healthcare practice.

9. A method for facilitating integration of automated applications within a healthcare practice, comprising:
building a user interface that examines a first and second automated application facility for data elements, wherein each automated application facility contains a set of data elements;
producing a graphical representation of each set of data elements;
displaying the graphical representation;
relating the set of data elements corresponding to the first automated application facility with the set of data elements corresponding to the second automated application facility wherein the sets of data elements are related by connecting data stored in each set of data elements;
displaying the connected data elements;
tagging the connections to allow a user to define a set of business rules, wherein said business rules are associated with the connected data elements;
saving the business rules and associated data elements;
generating executable code pertaining to the saved business rules and associated data elements;
executing the code to generate a detailed log of the business rules and associated data elements; and
reviewing said log to determine the existence of errors in the integration of the first and second automated application facilities.

10. The method of claim 9, wherein the data elements corresponding to information for a patient in a healthcare practice.

11. The method of claim 9, wherein the graphical representation is produced by an electronic document containing the requirements of the user interface.

12. The method of claim 9, wherein the graphical representation is produced by database schema automatically generated through interfacing with each automated application facility.
